(19) United States
(12) Patent Application Publication
(10) Pub. No.: US 2007/0239546 A1
(43) Pub. Date: Oct. 11, 2007

(54) Computer implemented interactive advertising system and method

(76) Inventors: Scott Blum, Jackson, WY (US); Andy Leak, Los Altos, CA (US); Geoff Schreiber, Portland, CA (US)

Correspondence Address: MITCHELL P. BROOK;C/O LUCE, FORWARD, HAMILTON & SCRIPPS LLP, 11988 EL CAMINO REAL, SUITE 200, SAN DIEGO, CA, 92130, US

(21) Appl. No.: 11/784,445

(22) Filed: Apr. 5, 2007

Related U.S. Application Data
(60) Provisional application No. 60/791,045, filed on Apr. 10, 2006.

(51) Int. Cl. G06Q 30/00

(52) U.S. Cl. 705/14

(57) ABSTRACT

A system and method of interactive advertising is provided in which an interactive media player is configured to allow user interaction as media having advertising is played. User interaction, such as by clicking a watermark, sends a signal with identifying information. Clicking the watermark and sending the signal does not interrupt the operation of the media player, such as by stopping the display of the content or opening another browser window. The user may selectively respond to advertisements and a user profile may be created based on the responses and/or the content that is played.

### CROSS REFERENCE TO RELATED APPLICATION

Priority is claimed to Provisional Patent Application Ser. No. 60/791,045, filed Apr. 10, 2006, the contents of which are incorporated herein by reference.

### FIELD OF THE INVENTION

The present invention relates to a system and method of advertising via interactive media that is accessible with a computer.

### BACKGROUND OF THE INVENTION

Online advertising is a growing industry correlated with growth of the Internet. There are various known forms of online advertising, such as graphical or textual advertisements, such as banner or pop-up advertisements, direct e-mail and paid search engine results. There are also abused forms of advertising, that might include unknown data mining, excessive e-mail known as “spam”, and malware such as spyware.

Graphical or textual advertisements often are found on Internet websites. These types of ads often appear along the top or sides of a webpage, or interspersed with text. Often they seek to attract click-throughs to linked websites or otherwise provide information. Often, a number of such ads maybe found on a single webpage. The creators of these different ads may design those ads to be animated, flash, or otherwise attempt to attract user attention, or stand out from the ad clutter. Intentionally or unintentionally intrusive ads also are known, which appear to promote a particular product or service, but actually redirect user to undesired websites or place unknown software on the user's system.

Pop-up advertising involves the opening of a browser window, in addition to windows that a user may have open on his or her computer desktop. The pop-up window may be opened on top of other windows, thereby obscuring work windows or websites of interest until the user closes or hides the pop-up, requiring additional keystrokes or mouse clicks. Likewise, pop-unders may open in a new window positioned underneath other open browser windows, thereby preventing the message or advertising from reaching the user for until space is cleared on the user's desktop, or the user otherwise accesses the pop-under window. Many users of the Internet have come to dislike pop-up or pop-under advertising to the point that they have set their software to block them or installed specialized anti-ad software. A drawback of such pop-up blocking is that most, if not all, of the pop-up advertisements are prevented from opening, thereby depriving the user of viewing those advertisements that may be of use or interest, and depriving the advertiser of consumer access.

Another form of Internet advertising involves search result placement. In such advertising, a search engine may position a paid link more prominently than other links found in a particular search. In another form of such advertising, an ad is positioned on a search results page, which may be on a subject correlated to the search context. An advantage of such advertising is that it targets ads to consumers who have indicated some interest via the search criteria. However a disadvantage of such advertising is diminished consumer trust in search results, and increased consumer skepticism of ads displayed in conjunction with searches.

Many users have come to distrust or ignore graphical or textual ads and pop-ups/unders, and seldom if ever click on such known forms of Internet advertising. As a result of this, the effectiveness of known forms of Internet advertising may have diminished, even for advertisements of a subject matter of interest.

Another form of Internet advertising is conducted via e-mail. The term “spam” has been coined as a reference to bulk e-mail advertising. Some advertisers have adopted spam practices viewed as unsavory, such as using false or misleading titles and messages intended to lure the recipients into clicking on a link. These messages may contain subject matter that is offensive to user segments or involve otherwise illegal solicitations. Moreover, the spam message also may indicate a false origin. Such messages may be associated with “phishing”, a practice which relies on fraud and deception to trick a user into taking certain actions, such as clicking on a particular link or sharing certain information. Such misuse of e-mail advertising has led to further consumer skepticism and a decline in advertising effectiveness. For example, some computer users may refuse to open e-mail ads. Thus, messages from desired sources may never be opened and read. Or, even if the e-mail message is desired, the recipient may delete the message within the spam clutter by mistake.

Spyware or malware includes software surreptitiously installed on a user's computing device or Internet browser. These programs may cause unwanted pop-ups in an infected device, or otherwise intrude on a user's privacy. The pop-ups may be of an offensive nature and may expose users to images that may not be appropriate for all age groups. These programs may also attempt to develop a “profile” of Internet or computer usage that may be sent to advertisers unbeknownst to the user. Additionally, such a profile may be flawed if multiple users share a computer, or a particular user is directed to undesired websites by misleading banner ads or other similar deception. Internet users generally are averse to the unauthorized installation of software that shares their personal information or profile, and are concerned about the other malicious capabilities of such spyware advertising programs. Anti-spyware and anti-malware programs are increasingly known, and automatically strips the spyware and malware from a user's computer.

Accordingly, there is a need for a system and method of advertising that allows a user to view advertising in a safe and trusted manner via the Internet. Likewise, there is a need for a system and method of advertising that relies on voluntary assent by the user to view the ad. There is a further need for directed advertising, rather than, for example, banner ads or spam to wide audiences. There further exists a need for a reliable manner in which advertisers may efficiently communicate with a receptive audience.

### SUMMARY OF THE INVENTION

The present invention alleviates to a great extent the disadvantages of the known Internet advertising systems by providing a system and method of directing advertising to a user and allowing the user to determine whether she would like to receive additional information on the advertised product or service. In this regard, the user is presented with advertisements that are displayed concurrently with an interest indicator and the system in turn provides a specified contact with the advertising sponsor. The sponsor then can provide information, coupons, etc. to the particular user, avoiding the inefficiency, waste, and annoyance typically engendered with Internet advertising.

In an embodiment of the present invention, a method of advertising is provided in which interactive media is presented to the target audience, wherein a user may indicate an interest in an advertisement while still enjoying the interactive media without interruption when presented with advertising. In this regard, the interactive media includes advertisements that may be integrated with, or supplemental to, a primary feature. In operation, an indicator is provided, such as an icon or watermark that may be activated by the user such as by clicking. Activation of the indicator results in additional data, information, or advertising being delivered to the user, preferably in a manner that does not interrupt the feature, such as at a later time after the primary feature has concluded. Hence, users enjoying a feature may receive additional information on products and services of interest, but are still able to enjoy the feature without closing the display window to receive the additional information. Moreover, future advertisements may be tailored to a specific set of users, or individual users, based on learned preferences or media selections.

In one embodiment, the display of the indicator is synchronized to the feature by use of a script. The script may govern the timing of display of the watermark and the timing of ads included with the feature, and may also provide directional control associated with user clicks on the indicators. Additionally, the system may access user-specified data in generating scripts, coordinating targeted advertisements to play at designated times.

According to an embodiment of the present invention, a computer user is the target of interactive media advertising. The user desires to enjoy some entertainment, for example an online video, and proceeds to watch that video on an interactive media player or browser software. At one or more times as the video is playing, a user-selectable indicator, such as an icon or watermark is displayed that may be clicked to denote interest in an advertised product or service. In some examples, the indicator displayed may be tied to a product depicted or deliberately positioned in a portion of the video, such as the brand of car driven by a character, or may refer to a related product, such as a local car repair facility advertised during a scheduled commercial break. Alternatively, ads are included in the video, such as a television program. When a user is interested in learning more about the product or service, she may click on the indicator.

The indicator may be a “watermark”, which is referred to herein as an overlay that is associated with the video image or a portion of it, either visible or invisible to the user. Another example of an indicator is a separate icon that is displayed on the media player or elsewhere on a user's computer desktop. It should be understood that any user-activatable indicator can be selected. In a preferred embodiment, the indicator only appears when an advertisement is being played or at any other time in which user input may be desired. When pressed or clicked, the indicator optionally may flash or a brief tone may sound to alert the user that the user's clicking action has been recognized as a user-confirmation. When the indicator is clicked, a signal may be sent to the advertiser or affiliate, who in turn may contact the user via the media player, e-mail, telephone, or other form of communication. The video may continue to play without interruption during this process.

In an aspect of the present invention, a clickable list of advertisements is provided, for which the user indicated interest. This list, referred to as the “Response Queue” herein, preferably includes a list of the advertisers and/or advertised products or services, as well as a hyperlink to an information page such as the advertiser's website or to an open e-mail window. Text, images, and HTML text also may be incorporated in the Response Queue. The Response Queue may also include delete buttons that may be used to selectively delete an advertiser's information from the Response Queue. The Response Queue further may display the most recently selected ads in a scrolling list of selected ads, and allow the user to use a scrolling feature to view previously-selected ads.

It will be appreciated that an interactive media player in accordance with the present invention may be used to display video or other content on a variety of devices, such as computers, laptops, telephone handsets, cellular phones, televisions, personal data assistants (PDAs), media-players and so on.

These and other features and advantages of the present invention will be appreciated from review of the following detailed description of the invention, along with the accompanying figures in which like reference numerals refer to like parts throughout.

### BRIEF DESCRIPTION OF THE DRAWINGS

FIG. 1 is a diagrammatic illustration of an Internet advertising system in accordance with the present invention;

FIG. 2 is flowchart illustrating processing steps in accordance with the present invention;

FIG. 3 is an embodiment of an interactive media player incorporating advertising features in accordance with the present invention;

FIG. 4 is a flowchart illustrating processing steps in accordance with the present invention;

FIG. 5 is flowchart illustrating processing steps for updating a user profile in accordance with the present invention;

FIG. 6 is flowchart illustrating processing steps for updating a user profile in accordance with the present invention;

FIG. 7 is flowchart illustrating processing steps for updating a user profile in accordance with the present invention;

FIG. 8 is flowchart illustrating processing steps for updating a user profile in accordance with the present invention;

FIG. 9 is flowchart illustrating processing steps for updating a user profile in accordance with the present invention;

FIG. 10 is an embodiment of an interactive media player incorporating advertising features in accordance with the present invention;

FIG. 11 is an embodiment of an interactive media player incorporating advertising features in accordance with the present invention;

FIG. 12 is an embodiment of an interactive media player incorporating advertising features in accordance with the present invention.

### DETAILED DESCRIPTION OF THE INVENTION

In the following paragraphs, the present invention will be described in detail by way of example with reference to the accompanying drawings. Throughout this description, the preferred embodiments and examples shown should be considered as exemplars, rather than as limitations on the present invention. As used herein, the “present invention” refers to any one of the embodiments of the invention described herein, and any equivalents. Furthermore, reference to various aspects of the invention throughout this document does not mean that all claimed embodiments or methods must include the referenced aspects.

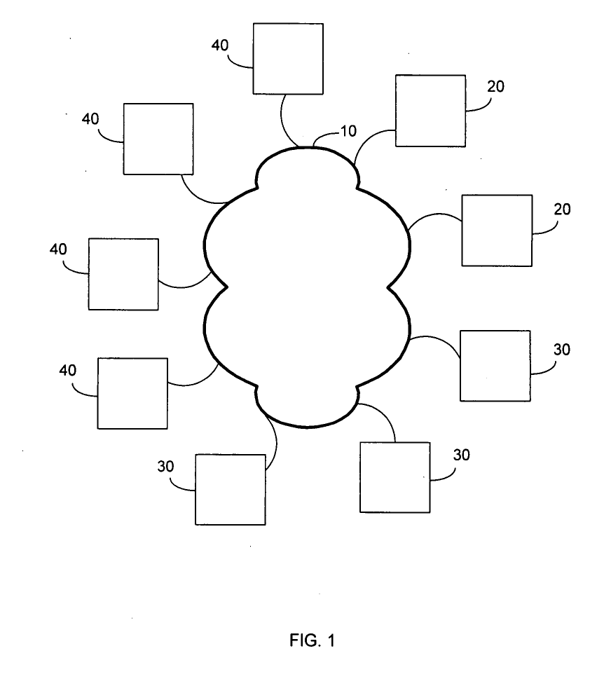

An Internet advertising system is illustrated in FIG. 1, in which reference number 10 points to a representation of an electronic communications network (“ECN”), such as the Internet or other user accessible network. An advertising provider is illustrated with reference number 20, and the advertising provider may offer an interactive media player or desktop controller (collectively referred to as “media player”) in accordance with an aspect of the present invention. Likewise the advertising provider may furnish other content, in addition to advertising selections. In one embodiment, advertising providers have associated websites also indicated with reference number 20. Advertisers are illustrated with reference number 30, and also may have associated websites. They also may be referred to in this description as “Internet commerce websites” or “retailer websites”. Examples of advertisers include businesses and/or websites that offer goods and/or services to consumers or businesses, are information providers, such as on-line news services, directories, encyclopedias, travel service providers and so on. Of course it is understood that advertisers can have websites 30 encompassing one or more computer or server systems providing storage capacity storing database modules of product information and prices, product information pages, customer information, order information, etc.

In terms of hardware and software implementation, advertisers 30 and advertising providers 20 may include the requisite computing equipment and software for storage of electronic or optical data, receiving and transmitting signals via an ECN, either wired or wireless, and providing to users 40 web page displays. For example, advertiser websites 30 may include database modules storing one or more advertisements that may be displayed via an interactive media player provided by advertising provider websites 20, as discussed further below. Alternatively, advertising content provide by the advertising providers 20 may reside within such hardware at the advertising providers 20. Also operating on the Internet are plural users (or consumers) who access ECN 10 via their access systems 40, whether computers, laptops, telephone handsets, cellular phones, televisions, personal data assistants (PDAs), media players and so on.

The invention is further described with reference to the Internet commerce websites' 30 method of operation, the advertising suppliers' 20 method of operation, and the users' 40 method of responding to an advertisement.

An advertising provider website 20 may offer an interactive media player 50 capable of displaying images, playing audio or video, and/or displaying text. Preferably, the interactive media player is configured to play selected types of content, and more preferably the content includes video files, such as mpeg, wmv, avi, rm, asx, divx, or psp formats, for example. As used herein, the term “content” refers to any format of media including text, audio files, image files, or video files, and that is capable of transmission via the Internet 10.

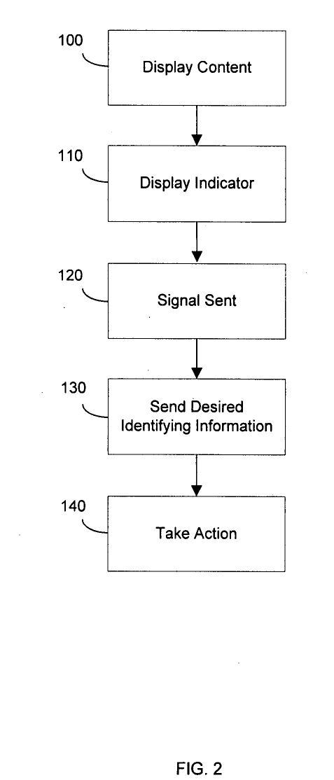

Referring now to FIG. 2, a method of advertising is described in accordance with one aspect of the present invention. This method is described in usage with an interactive media player that is configured to display video images and other content. The content may be displayed on a video display, as illustrated in step 100. For example, the content may be a motion picture that was previously downloaded from the Internet 10. The content may be available for download at no charge to the user, and may include predetermined time periods available for the display of advertisements, which may be preselected or may be determined based on factors such as user preferences, genre of the content, seasonal events, or the like. It will be appreciated that the present invention maybe practiced with almost any device having a video display, such as cell phones, ATMs, iPods, video-enabled pumps at gasoline stations, vlogs, podcasts, etc. The device is preferable configured as an interactive media player.

At a predetermined time, an advertisement may be shown in the video display of the interactive media player. The advertisement may be shown as part of the content itself or as a separate commercial. For example, if the content is an episode from a cooking series, the chef may be using a particular brand of mixer. In that example, the chef may mention the brand of the mixer as the display shows a close-up view of the mixer. In contrast, the advertisement may be an unrelated commercial, such as a 30-second advertisement that is played during the same cooking segment. The separate commercial may or may not be directly related to the cooking show, as it may advertise a particular line of clothing, for example.

In either of the above-described scenarios, as the advertisement is displayed, an indicator comprising a watermark, icon, or active click region is displayed to the user, as illustrated in step 110. For example, a semi-opaque watermark may be shown as an overlay atop the video display. Alternatively, or in addition, an icon may be displayed in another region of the media player. As yet another alternative, the video display itself may be activated as an active click region that recognizes and accepts clicks from the user. It should be understood that “clicking” as used herein refers to any form of selection or designation operation, and is not limited to the activation of a button on a computer mouse or keyboard.

When a click is received in response to an advertisement, the interactive media player preferably sends a signal to the user acknowledging that the click was recognized, as illustrated in step 120. This signal may be manifested by a visual or audio manner, such as an audio tone, a flashing of the watermark or logo, or a change in the physical appearance of the indicator (such as altering a watermark or icon to be a different color, different size, or briefly animated).

In a preferred embodiment, this signal does not disturb the display of the content on the video display, as the content preferably continues to play. Control features of the interactive media player allow the user to pause, stop, or otherwise control the video display in a conventional manner, although some or all of these features may be temporarily disabled, as discussed below. In embodiments allowing user control, a user desiring to stop the display of the content in order to pursue an advertisement is able to do so easily. This feature may be useful for advertisements that offer an incentive to respond quickly, within a certain time, or within a preselected number of responses from a larger group of users.

In accordance with another aspect of the present invention, the interactive media player may be selectively reconfigured for the display of advertisements. For example, a media player having buttons or other controls to allow a user to “fast forward” or “skip” to a later portion of the content may be selectively altered to temporarily disable the advancement features as the advertisement is playing.

In addition to preferably signaling the user that a click was recognized, information also is conveyed to the advertiser in step 130. This step may be performed before, after, or simultaneously with step 120. In this step, the interactive media player preferably sends user information, such as a user name and e-mail address, to the retailer website 30, but alternatively comprises sending user information to a processing service or other entity affiliate with the retailer website 30. In a preferred embodiment, the communication from the interactive media player to the retailer website 30 also includes the identity of the particular advertisement in which the user expressed interest, as well as the identity of the particular content that the user was watching, and the time that the request was made by the user 40.

Once the retailer website or its affiliate receives the transmitted information, further marketing may be conducted as desired, as illustrated in step 140. For example, the advertiser may take a variety of actions, including sending the user an e-mail message with a coupon or information regarding the product or service of interest, initiating contact by a sales representative, or providing the user with contact information for a sales representative. It should be clear that the nature of the advertiser's response may vary greatly from advertiser to advertiser, and perhaps even between product to product for a particular advertiser. In any event, the user 40 preferably should be provided with additional information in response to the user's request.

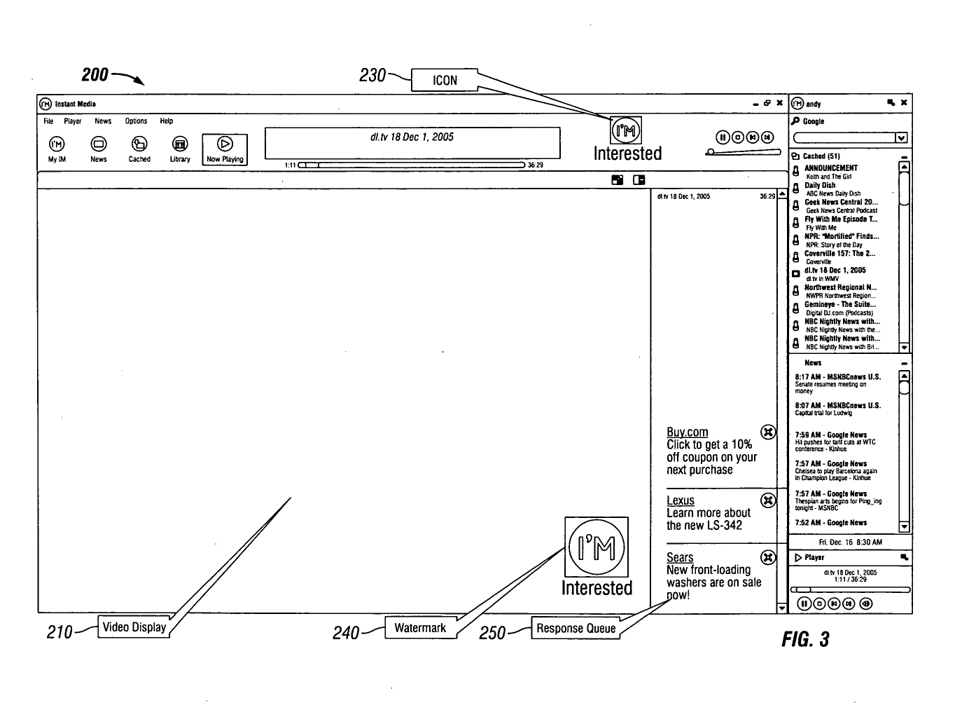

The process described above and in FIG. 2 may be demonstrated in part by example. In this regard, FIG. 3 illustrates one embodiment of an interactive media player incorporating features of the present invention. Interactive media player 200 preferably includes video display 210, control buttons 220, indicator in the form of icon 230 and/or watermark 240, and Response Queue 250. Other features may be included, as are commonly found on known media players, such as content information, time counters, full screen option menu tabs or buttons, and playlists. In some embodiments, as in FIG. 3, interactive media player 200 may be skinned with the operating system, whereas other embodiments may include a non-skinned media player.

In the embodiment shown in FIG. 3, content having images or video may be displayed in video display 210, whereas video display 210 optionally may display predetermined graphics or be absent for audio-only content. Watermark 240 may be displayed on the video display 210 atop the video content at a predetermined time. In a preferred embodiment, watermark 240 is semi-opaque, relatively small, and located at the lower right corner of video display 240. It should be understood that other locations, sizes and degrees of opacity ranging from full to none also may be selected for watermark 240. For example, watermark 240 may be clear and overlaying the entire video display. In some embodiments, watermark 240 may be absent, and the user's click response is obtained via icon 230.

Icon 230 is another form of indicator that optionally may be included as part of the media player, but is preferably displayed in a location other than the video display 210. Icon 230 may be included in addition to, or in place of, watermark 240. Thus, in describing the use and operation of present invention, steps involving display or clicking of watermark 240 may be practiced with icon 230 instead, unless the context clearly shows otherwise.

Watermark 240 may be selectively activated and displayed according to a control script. One example of a control script follows:

Example_Script.xml

```
<IM-Control-Script>
  <Ad-Sequence>
    <ad name=“ad1” watermark-on=“00:00” watermark-off=“00:30”/>
    <ad name=“ad2” watermark-on=“00:30” watermark-off=“01:00”/>
    <ad name=“ad3” watermark-on=“05:00” watermark-off=“05:30”/>
  </Ad-Sequence>
  <ad-definition name=“ad1” skip=“no”>
    <interest-msg-address>response-im@buy.com</interest-msg-address>
    <response-title>Buy.com</response-title>
    <response-URL>www.buy.com/im-ad-23.htm</response-URL>
    <response-text>
      Click to get a 10% off coupon on your next purchase.
    </response-text>
  </ad-definition>
  <ad-definition name=“ad2” skip=“no”>
    <interest-msg-address>response-im@lexus.com</interest-msg-
    address>
    <response-title>Lexus</response-title>
    <response-URL>www.lexus.com/im-ad-99.htm</response-URL>
    <response-text>
      Learn more about the new LS-342.
    </response-text>
  </ad-definition>
  <ad-definition name=“ad3” skip=“no”>
    <interest-msg-address>response-im@sears.com</interest-msg-
    address>
    <response-title>Sears</response-title>
    <response-URL>www.sears.com/im-ad-14.htm</response-URL>
    <response-text>
      New front-loading washers are on sale now!
    </response-text>
  </ad-definition>
</IM-Control-Script>
```

The above script may be used to combine three advertisements with the content, although it will be clear that any number of ads may be used. The first advertisement, “ad1”, is a 30-second advertisement for Buy.com. When the content is selected for playing on the media player, the control script directs ad1 to begin playing and also activates the watermark 230 for display for 30 seconds, the duration of the advertisement. As ad1 is playing, the fast-forward feature of the media player is disabled, thereby preventing the user from “skipping” the advertisement and advancing the playback forward. Preferably, other selected features remain enabled, such as pause and rewind controls.

If a user is interested in the Buy.com advertisement, the user may click indicator (e.g., watermark 240, icon 230, or active click region). If watermark 240 is clicked while ad1 is playing, a signal is sent. In this example, an e-mail will be sent to response-im@buy.com that preferably provides the user's contact information, such as the user's e-mail address. Additionally, the user may receive additional information in Response Queue 250. In this example, the additional information includes the identity of the advertiser, Buy.com, and the nature of the advertisement or promotion, here “Click to get a 10% off coupon on your next purchase.” Moreover, the identity of the advertiser is a clickable hyperlink, and in this example clicking on the Buy.com advertiser name is opens a browser window and displays the contents of the website located at www.buy.com/im-ad-23.htm, preferably in a separate window. It will be appreciated that in addition to text and hyperlinks, Response Queue 250 also may display additional information in the form of images or other HTML text.

It should be clear that clicking on ad2 and ad3 in the present example also provides information regarding Lexus and Sears, respectively, as illustrated in FIG. 3. Of course, similar e-mail notifications would be sent to each advertiser, as well. In accordance with one aspect of the present invention, if the user is watching content on the media player that has been previously downloaded, and the user is not on-line, the e-mail notifications may be queued or delayed until a connection to ECN 10 is reestablished.

In a preferred embodiment, scripts are created to accommodate advertisements that are standardized in duration, such as 15-second, 30-second, and 60-second commercials, although advertisements of any length may be used, including full length “infomercials”.

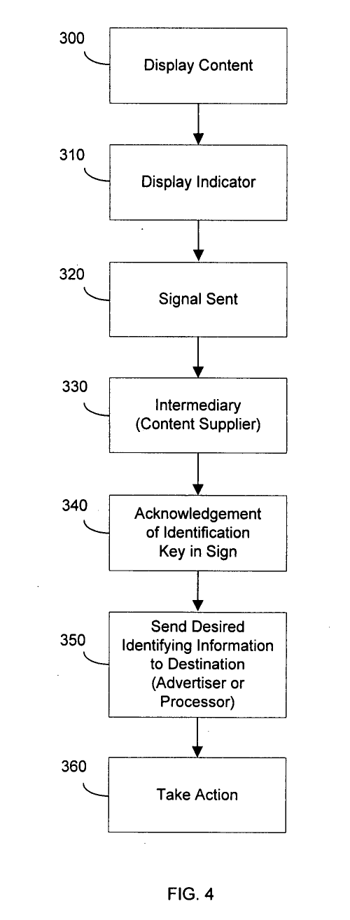

Referring now to FIG. 4, an alternative method of advertising in accordance with the present invention is shown. This method is described in usage with an interactive media player that is configured to display video images and other content. The content may be displayed on a video display, as illustrated in step 300. For example, the content may be a motion picture that was previously downloaded from the Internet 10. The content may be available for download at no charge to the user and may include predetermined time periods available for the display of advertisements, which may be preselected or may be determined based on factors such as user preferences, genre of the content, seasonal events, or the like.

At a predetermined time, an advertisement may be shown in the video display of the interactive media player. The advertisement may be shown as part of the content itself or as a separate commercial. For example, if the content is an episode from a home improvement series, the carpenter may be using a particular brand of power tool. In that example, the carpenter may mention the brand of the power tool as the display shows a close-up view of the power tool. In contrast, the advertisement may be a separate commercial, such as a 30-second advertisement that is played during a preselected commercial break in the same home improvement segment. The separate commercial may or may not be related to the home improvement show, as it may advertise a particular line of clothing.

In either of the above-described scenarios, as the advertisement is displayed, an indicator is displayed to the user, as illustrated in step 310. For example, a semi-opaque watermark may be shown as an overlay atop the video display. Alternatively, or in addition, an icon may be displayed in another region of the media player. As yet another alternative, the video display itself may be activated as an active click region that recognizes and accepts clicks from the user. It should be understood that “clicking” as used herein refers to any form of selection or designation operation, and is not limited to the activation of a button on a computer mouse or keyboard.

When a click is received in response to an advertisement, the interactive media player preferably sends a signal to the user acknowledging that the click was recognized, as illustrated in step 320. This signal may be manifested by a visual or audio manner, such as an audio tone, a flashing of the watermark or logo, or a change in the physical appearance of the indicator (e.g., a different color, different size, or a brief animation).

In a preferred embodiment, this signal does not disturb the display of the content on the video display, thereby allowing the content to continue to play. Nevertheless, some or all of the control features of the interactive media player may be active, allowing the user to pause, stop, or otherwise control the video display in a conventional manner. In this regard, a user desiring to stop the display of the content in order to pursue an advertisement is able to do so easily. This feature may be useful for advertisements offering an incentive to respond quickly, within a certain time, or within a preselected number of responses from a larger group of users.

In accordance with another aspect of the present invention, the interactive media player may be selectively reconfigured as an advertisement is playing. For example, a media player having buttons or other controls that allow a user to “fast forward” or “skip” to a later portion of the content may be selectively reconfigured to temporarily disable the advancement features as the advertisement is playing.

In addition to preferably signaling to the user that a click was recognized, information also is conveyed to an intermediary, such as a content supplier, in step 330. This step may be performed before, after, or simultaneously with step 320. In this step, the interactive media player preferably sends user information, such as a user name and e-mail address, to the intermediary, which preferably is advertising provider website 20.

In step 340, the intermediary may optionally acknowledge the user's request and identification and also store data relating to that request. This stored data may be used for subsequent selection of relevant advertisements to accompany content. In this regard, the content may be selected as specific to the user (“the user was interested in Buy.com”), or as related to the content (“30 percent of all users watching this particular content were interested in the new Lexus”), or the like (“7 percent of all users who watched any video content were interested in washers from Sears”).

In step 350, the intermediary may signal the advertiser or retailer website (or its affiliate) and indicate that a user expressed interest or desired further information as related to an identified advertisement. The intermediary may send information that may be used to identify or contact the user, such as an e-mail address or telephone number. The intermediary also may send usage or statistical reports related to the advertisement, such as the number of users that expressed interest relative to the number of users who were exposed to the advertisement. The report may be given as an aggregate report that does not identify the user, such as by providing the viewing time, number of clicks, and selected profile information. Alternatively, the report may be an individual report that includes information identifying the user.

Once the retailer website receives the transmitted information, further marketing may be conducted as desired, as illustrated in step 360. For example, the advertiser may take a variety of actions, including sending the user an e-mail message with a coupon or information regarding the product or service of interest, initiating contact by a sales representative, or providing to the user with information listing contact information for a sales representative. It should be clear that the nature of the advertiser's response may vary greatly from advertiser to advertiser, and perhaps even between product to product for a particular advertiser. In any event, user 40 preferably should be provided with additional information in response to the user's request.

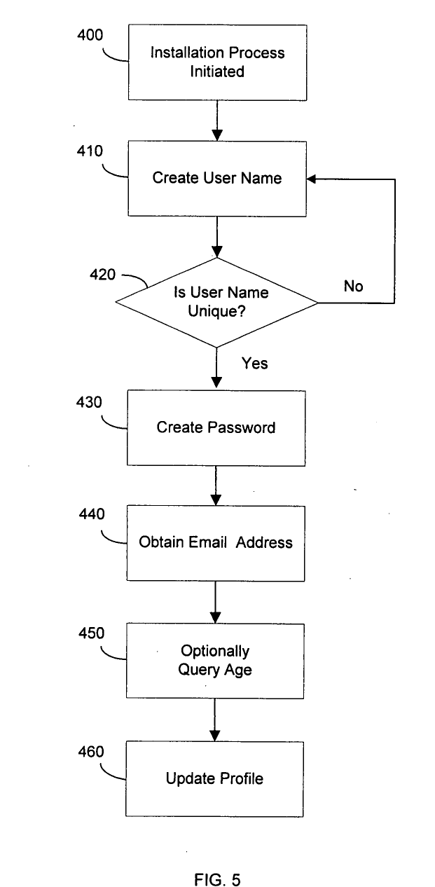

FIG. 5 shows a flow chart containing steps in an installation process of a media player incorporating features in accordance with the present invention. A user 40 who wishes to install an interactive media player on a computer system, cell phone, PDA, or like device may initiate the process through known means, such as downloading information over an ECN 10, or using CDs and other storage media. The process is initiated in step 400. As part of the installation process, the user may create a user name, in step 410. This step may be automated, as in the scenario in which the user is installing the player on a cell phone and the user name is the cell phone number. Alternatively, the user name may be selected manually, as commonly occurs with selecting user names over the Internet. Once a user name is selected, it may be compared to other user names to determine whether the name is unique, as shown in step 420. In the event the user name is not unique, the user may be returned to step 410 to select a different name.

In step 430, a password is created. For example, the user may select a password associated with the user name, or a password may be generated automatically. The user's e-mail address also is obtained, in the step 440. It should be understood that these steps may be combined or reordered. For example, a user's e-mail address may also be used as a user name, satisfying steps 410 and 440.

Step 450 optionally queries the user's age. This step may be beneficial prior to providing content to the user, as particular types of content may not be suitable for all age groups for reasons of language, violence, or other considerations. This step may also be useful in determining which advertisements may be appropriate for the user. The media player may include features that limit the file transfer or viewing of certain types of content based on a user's age or other factors, such as parental controls.

The user's profile is updated in step 460. There, some or all of the user's information is saved. This information may be stored on a user's device 40, an advertising provider's website 20, or other location. Of course, the user's profile also may be updated at other times, such as after entry of any user information or following a user's selection of content, interest in a particular advertisement, or lack of interest in a particular type of product, for example.

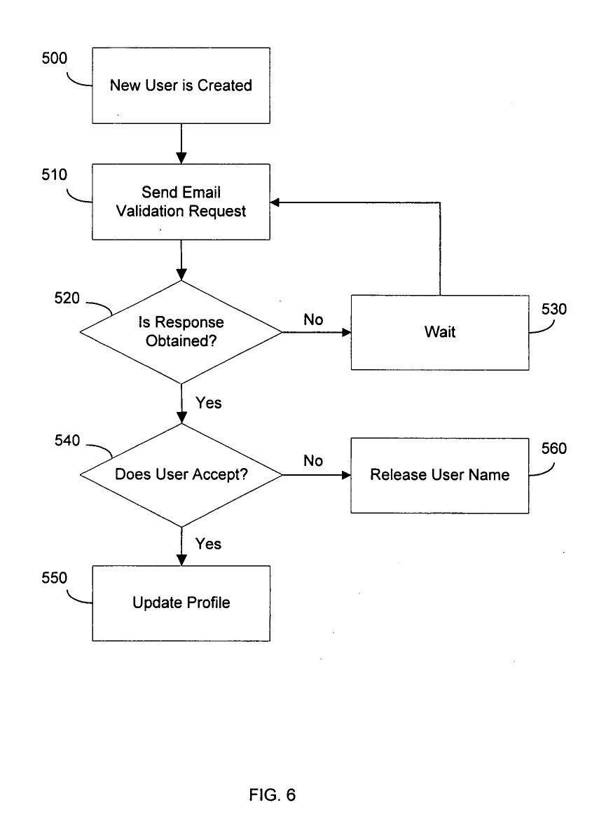

A user's profile also may be updated in response to a validation request that may be submitted following the creation of a user name, or at any other appropriate time, as shown in FIG. 6. A new user is created in step 500. This step may refer to some or all of the steps in FIG. 5, and preferably includes the steps of acquiring a user's e-mail address, telephone number, text messaging number, or other contact information. A validation request is submitted to the user's contact information in step 510.

Step 520 queries whether a response is received from the validation request. If no response is received, the system may wait for a predetermined time, as indicated in step 530, and then return to step 510 to resubmit a validation request. The waiting time of step 530 may be varied according to different factors including the number of time step 530 is visited.

Once a response is obtained at step 520, step 540 queries whether the user accepts the validation request. If so, the user's profile may be updated in step 550. Alternatively, the user name may be released in step 560.

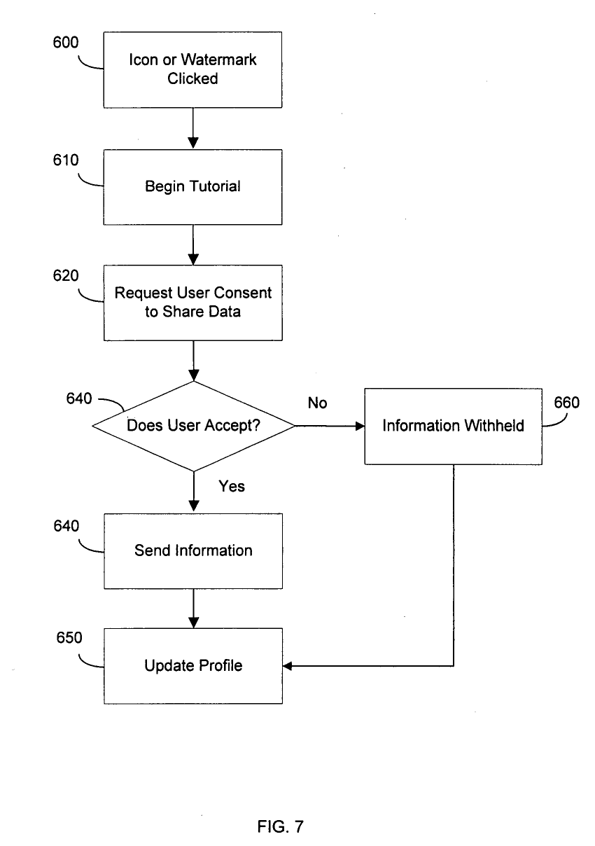

Referring now to FIG. 7, a method of updating a user's profile is depicted. Preferably, this method is conducted as part of the initial registration process or when a user first clicks an indicator. For purposes of example, FIG. 7 illustrates the method when used to update a user's profile when the user first clicks an indicator, or otherwise expresses interest in a certain advertisement. This expression of interest occurs in step 600. At this point, a tutorial is started that may explain the features of the media player or the types of information that may be shared with advertisers or other third parties, as shown in step 610.

Permission to share some or all of a user's information is requested in step 620. Step 630 queries whether the user has given permission to share some or all of the data. If permission is granted, the information may be sent to the database in step 640, and the profile may be updated accordingly in step 650 to reflect the user's preferences, selections, or other information. Alternatively, if the user does not give permission to share the information, the information is withheld in step 660, and the profile is updated to reflect the user's preferences.

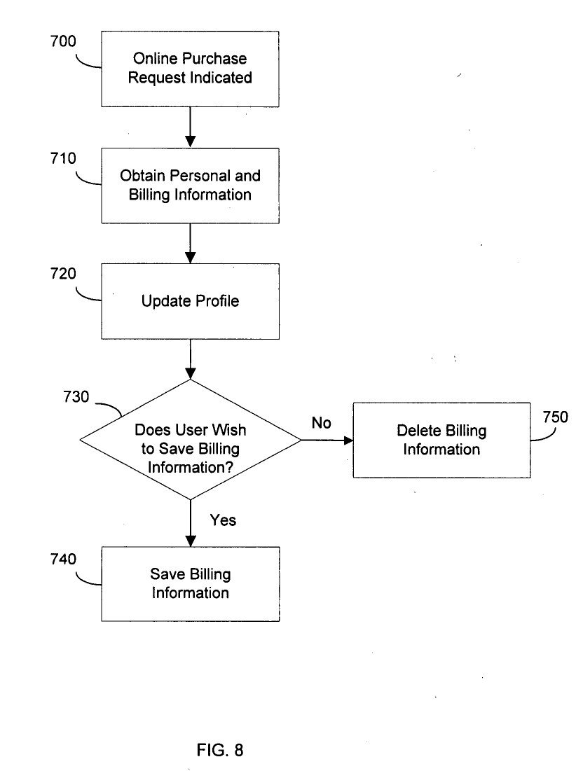

FIG. 8 depicts a flow chart showing another instance when a user's profile may be updated. Here, the updating occurs following an online purchase request. The online purchase may be for media content, goods, or services, for example. The user may make a purchase request in step 700. In response to the purchase request, the user may be asked to submit personally identifying information and billing information in step 710. The user's profile may then be updated to reflect this information in step 720. In step 730, the user is asked for permission to save user's billing information. If the permission is granted, the billing information is saved in step 740, whereas if permission is withheld the billing information is deleted in step 750. In either event, the profile may by updated to reflect the preferences.

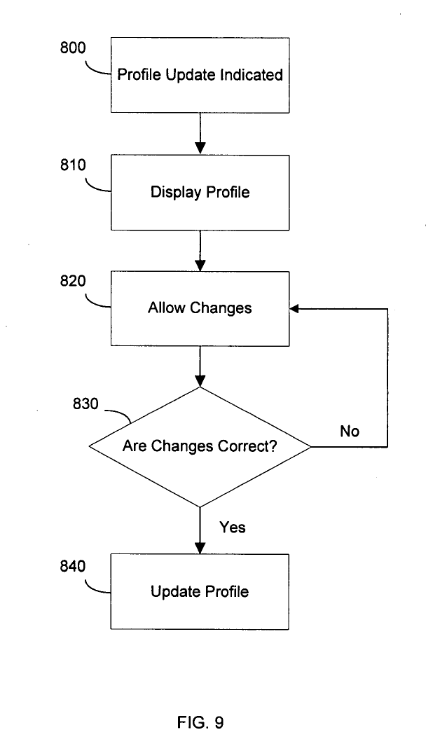

FIG. 9 illustrates the concept that a user's profile may be updated at other times, as well. In step 800, a profile update is indicated. This step may occur in response to a user actively accessing her profile to initiate a change, or may occur as part of a routine automated account maintenance procedure, for example. Once this aspect of the profile updating feature is activated, all or part of a user's profile is displayed to the user in step 810. Preferably, this display includes identifying information such as the user's name, address, and e-mail address. Optionally, it may include billing information, which maybe redacted to only show a portion of any credit card numbers.

A user may selectively update her profile in step 820. For example, if a user moves, she may enter her new address. Likewise, the user's interests or activities may be displayed, along with additional interests and activities that the user may select to include in her profile. The user may then select or de-select activities and interests as desired. She may, for example, de-select an interest in investing and select an interest in sky diving to reflect a change in hobbies.

Step 830 queries whether the changes are correct. This step may include displaying an updated profile to include the modified information. If the information is not correct or the user desires to further modify her profile, the method returns to step 820. Otherwise, the method continues to step 840 where the profile is updated and saved.

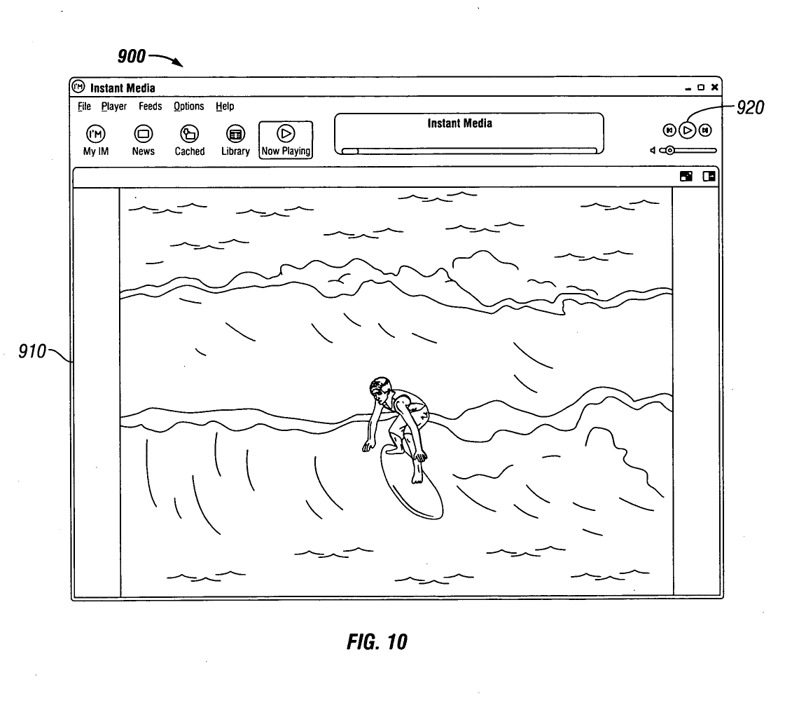

In accordance with another aspect of the present invention, an interactive media player may be provided having an information display screen that is selectively activated. FIGS. 10 to 12 depict an embodiment of such an interactive media player. Interactive media player 900 preferably includes resizable video display 910, control buttons 920, one or more indicators 930, and curtain 940 in which content 950 may be displayed. Curtain 940 may operate like a Response Queue or information display screen, as described above, but may be selectively activated and deactivated to allow for a larger mode of video display 910. In this regard, curtain 940 may be configured to appear after a user activates indicator 930. Alternatively or in addition, display of curtain 940 may be controlled by a control script. Other features may be included in interactive media player 900, such as content information, time counters, full screen option, menu tabs or buttons, and playlists. In some embodiments, interactive media player 900 may be skinned with the operating system, whereas other embodiments may include a non-skinned media player.

Features of interactive media player 900 may be described by way of example. For instance, FIG. 10 depicts interactive media player 900 configured such that resizable video display 910 is displayed in a large mode. This configuration may be appropriate for the display of program content in which no advertising is concurrently occurring, but could also be used with advertising.

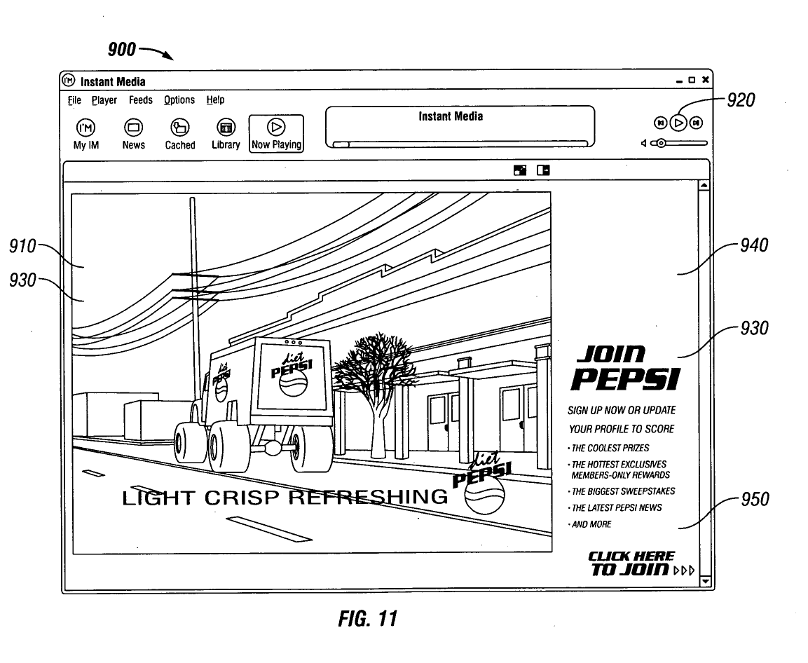

In FIG. 11, video display 910 is displayed in a smaller mode as compared to that of FIG. 10. In FIG. 11, curtain 940 is to the right of video display 910, and is used to display content 950. Content 950 in this example comprises text and graphics promoting Pepsi. A user may gain more information regarding content 950 by activating indicators 930, which are located as a clear overlay on video display 910 and as clickable content 950.

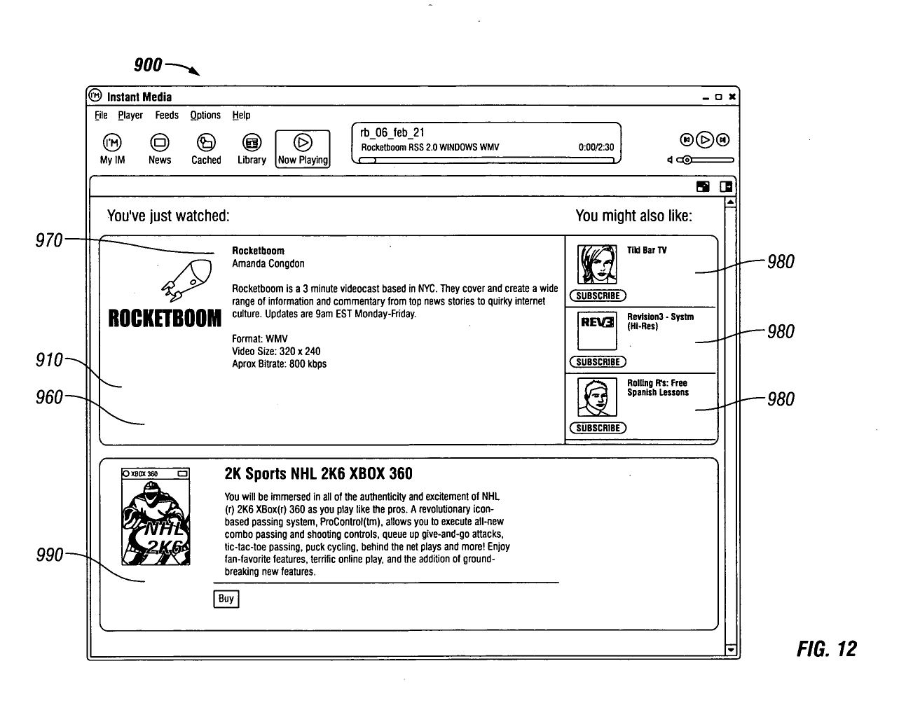

In FIG. 12, video display 910 is displayed in a large mode, and optional credits page 960 is displayed. Credits page 960 preferably comprises an interactive display screen depicting information such as the title, logo, and/or other descriptions of a show 970, related channels or shows that are available for viewing or subscription 980, other advertisements 990, HTML code that is displayed for every show on a given channel of a subscription service, HTML code that is displayed for a single show on a given channel of a subscription service, and Adwords, for example. The above-mentioned features may by used for click-thrus to a point of purchase, links to community sites for the show producer, display of embedded information, or other data. Other features that may be included in credits page 960 include a replay option, save, watch, share, rate, discuss, add to playlist, export to PMP, burn to DVD, and auto-summary of advertisers. In some embodiments, credits page 960 may be displayed following a show. Optionally, credits page 960 may be displayed concurrently with curtain 940.

Control of whether to provide curtain 940 or credits page 960, as well as control of other features such as the selection of advertisements, may by performed by control scripts. A first control script may be provided that defines how a collection of advertisements, video segments, and interactive credit pages are coordinated together and may operate in conjunction with a second control script that defines the timing and the content that appears in curtain 940.

The first control script may be used to support vlogs, television show sequences, and other media. This script may be generated manually or programmatically for automated ad-insertion. It should be understood that this script allows flexible insertion of advertisements, curtain 940, and/or credits pages 960 into the program. An example of a first control script, named Example_Vlog_Sequence.xml, is shown below.

Example_Vlog_Sequence.xml

```
<IM-Sequence>
    <video id=“RB12342” start=“00:00” stop=“END”/>
    <curtain id=“xx34” start=“00:00” stop=“END”/>
    <credits id=“cre-234”/>
</IM-Sequence>
```

In this script, the term “video id” refers to an identification of a particular vlog, television show, or other program. “Curtain id” refers to an identification of a particular second control script that may control curtain 940. And “credits id” refers to an identification of a particular credit page 960. Thus, in this example, a vlog identified as “RB12342” may be played concurrently with the display of curtain 940 and the associated content determined by the second control script. Once the vlog has been played in its entirely, credit page 960 is displayed.

In accordance with one aspect of the present invention, vlogs may be displayed concurrently with curtain 940 and any associated content. In accordance with another aspect of the present invention, a vlog may be played in its entirely, followed by the display of advertisements on video display 910 or curtain 940, followed by the display of credits page 960.

As another example of a first control script, a portion of a first control script named Example_TV-Show_Sequence.xml is shown below.

Example_TV-Show_Sequence.xml

```
<IM-Sequence>
    <curtain id=“Ford-234” start=“00:00” stop=“00:30”/>
    <curtain id=“Miller-717” start=“00:00” stop=“00:30”/>
    <video id=“Lost12342” start=“00:00” stop=“12:00”/>
    <curtain id=“FedEx-2343” start=“00:00” stop=“00:30”/>
    ...
</IM-Sequence>
```

In this embodiment, a show identified as “Lost2342” is displayed concurrently with curtain 940 for the first 30 seconds of the viewing. During this time, advertisements may be displayed on curtain 940 as determined by curtain-ids “Ford-234”, “Miller-717”, and “FedEx-2343”. After 30 seconds has elapsed, video display 910 may be displayed in a larger size as curtain 940 is removed or disabled. Later in the show other advertisements may be presented in a similar manner. It should be appreciated that the presence, ordering, and content of video display 910, curtain 940, and credits page 960 may be selectively altered as desired. Thus, in accordance with one aspect of the present invention, a show may be depicted on video display 910, preceded by, followed by, and/or interwoven with advertisements depicted on video display 910 or curtain 940. Likewise, credits page 960 may be displayed following these depictions or at another appropriate time.

Curtain 940 may be controlled by the second control script, as described above. This second control script maybe used to selectively activate and control content 950, provide rules for ad-insertion, and provide other features as described herein. One example of a second control script follows and is named Example_Curtain.xml.

Example_Curtain.xml

```
<IM-Curtain id=“Buy-334”>
    <video id=“TruckVid01” skip=“no”/>
    <max-impressions=“5”/>
    <display-category=“extreme-sports”/>
    <Message-Timing>
        <msg name=“msg1” on=“00:00” off=“00:15”/>
        <msg name=“msg2” on=“00:15” off=“00:30”/>
    </Message-Timing>
    <msg-definition name=“msg1”>
        <a href=“http://www.buy.com/offer343”>Discount coupon</a>
        <br>
        Click here to get a 10% off coupon from Buy.com.
    </msg-definition>
    <msg-definition name=“msg2”>
        <a href=“http://www.lexus.com/ls342”>Lexus</a><br>
        Learn more about the Lexus 342
    </msg-definition>
</IM-Curtain>
```

This script controls the playing of a video named “TruckVid01” in video display 910, disabling skip features during that playing, as previously discussed. During the first 15 seconds of this video, a message named “msg1” (for Buy.com) is displayed in curtain 940, followed by message “msg2” (for Lexus) for another 15 seconds. It will be appreciated that other scripts may operate concurrently, allowing the display of other content 950 in curtain 940 as the video is playing. The above script associates the included material with a display category of “extreme-sports”, which may be beneficial for selecting appropriate advertising when automating the scripting process.

Credits pages 960 may be determined in part by the selection of the media by the user. For example, in FIG. 12, a user who has selected an episode of RocketBoom for viewing may be presented with credits page 960 following conclusion of that episode. Credits page 960 displays the title, logo, and descriptions of RocketBoom 970, as well as related channels or shows that are available for viewing or subscription 980 that have been preselected based on associations to RocketBoom. Moreover, other advertisements 990 may be included in credits page 960. The other advertisements 990 may be selected based on the selection of media, the display category, and/or other factors, or may be selected through a script that enables insertion of custom HTML. One example of such customization is contained within a script, named Example_Credit.xml, as shown below.

Example_Credit.xml

```
<IM-Credit id=“Credit1”>
    <display-title=“Yes”/>
    <display-sponsors=“Yes/>
    <display-footer=“Yes/>
    <Credit-HTML>
        Click <a href=“http://www.ford.com/fanclub”>here</a>
        to visit the Ford Fan Club.
    </Credit-HTML>
</IM-Sequence>
```

Here, the script defines a credits page 960 named “Credit1”, which displays the title of the show, the sponsor of the show, additional information in the footer, and also a preselected advertisement for Ford. Of course, it should be understood that additional information may be included in the credits page 960, as discussed above.

Thus, it is seen that a system and method of interactive advertising are provided. One skilled in the art will appreciate that the present invention can be practiced by other than the preferred embodiments which are presented in this description for purposes of illustration and not of limitation, and the present invention is limited only by the claims that follow. It is noted that equivalents for the particular embodiments discussed in this description may practice the invention as well.

What is claimed is:

1. An interactive advertising system comprising:
a media player including a content display, the content including associated advertisements or departure points;
the content display including an overlay region configured to initiate a signal output upon activation; and
wherein the media player is configured to display uninterrupted content during the activation of the overlay region.

2. The interactive advertising system as recited in claim 1 wherein the overlay is actuated by a user selection operation.

3. The interactive advertising system as recited in claim 2 wherein the media player further comprises a display region and the overlay region corresponds to at least a portion of the display region.

4. The interactive advertising system as recited in claim 1 wherein the media player is configured to selectively advance the playback of the content at a rate exceeding the normal playback rate and wherein the control script comprises a command that prevents advancement of the playback of the content at a rate exceeding normal playback rate.

5. The interactive advertising system as recited in claim 4 wherein the media player is configured to activate a tone when the watermark is activated.

6. The interactive advertising system as recited in claim 1 wherein the media player is skinned to an operating system.

7. The interactive advertising system as recited in claim 2 wherein the media player further comprises an information display region for displaying information related to advertising.

8. The interactive advertising system as recited in claim 7 wherein the media player is configured to update the displayed information related to advertising in response to activation of the watermark

9. The interactive advertising system as recited in claim 1 wherein the control script further comprises a command to transmit a notification if the clickable region is activated.

10. A method of interactive advertising comprising:
providing a media player having operative features and configurable to play content having advertisements, a control script that controls one or more of the operative features, and a clickable region configured to transmit a signal upon activation during the operation of the media player, wherein the media player is configured to display uninterrupted content during the activation of the clickable region;
permitting a user to activate the clickable region, and
responding to activation of the clickable region.

11. The method as recited in claim 10 wherein permitting a user to activate the clickable region comprises displaying a clickable watermark.

12. The method as recited in claim 11 wherein responding to activation of the clickable region comprises displaying information related to an advertisement.

13. The method as recited in claim 11 wherein responding to activation of the clickable region comprises sending a signal having user information.

14. The method as recited in claim 13 wherein sending a signal having user information comprises sending a signal with user information to an advertiser website.

15. The method as recited in claim 13 wherein sending a signal having user information comprises sending a signal with user information to an advertising provider website.

16. The method as recited in claim 10 further comprising providing content to be played on the media player.

17. The method as recited in claim 16 further comprising configuring the control script to activate the clickable region to correspond with the playing of advertisements.

18. The method as recited in claim 10 further comprising maintaining a user profile.

19. The method as recited in claim 18 further comprising updating the user profile in response to user actions.

20. A method of interactive advertising comprising:
providing a media player configurable to play content having advertisements and a clickable region configured to transmit a signal upon activation during the operation of the media player, wherein the media player is configured to display uninterrupted content during the activation of the clickable region;
providing registration capabilities for registering the media player;
creating a user profile having user information;
allowing the user to activate the clickable region; and
sending a signal having user information in response to activation of the clickable region.
